(19) United States
(12) Patent Application Publication
(10) Pub. No.: US 2023/0191644 A1
(43) Pub. Date: Jun. 22, 2023

(54) GANTRY DRIVE SYSTEMS FOR LIQUID JET CUTTING SYSTEMS AND OTHER MATERIAL PROCESSING MACHINES, AND ASSOCIATED DEVICES AND METHODS

(71) Applicant: OMAX Corporation, Kent, WA (US)

(72) Inventors: Brian K. Guglielmetti, Bonney Lake, WA (US); Dustin Osterhaus, Tacoma, WA (US)

(21) Appl. No.: 18/069,892

(22) Filed: Dec. 21, 2022

Related U.S. Application Data
(60) Provisional application No. 63/292,373, filed on Dec. 21, 2021.

(51) Int. Cl. B26D 7/26; B26F 1/26

(52) U.S. Cl. CPC B26D 7/2628; B26F 1/26

(57) ABSTRACT

A system for moving a cutting device gantry or similar structure on a material processing machine can include a mounting structure configured to be operably coupled to the gantry and a drive assembly movably coupled to the mounting structure. The drive assembly can be configured to move the mounting structure and the gantry in a first direction relative to a gantry guide shaft of the material processing machine. The drive assembly can also be movable relative to the mounting structure in a second direction, perpendicular to the first direction. In some embodiments, the system includes one or more guide wheels rotatably coupled to the mounting structure. Each of the guide wheels can include an annular outer portion having curvature configured to complimentarily engage the gantry guide shaft. The annular outer portion can be resiliently deformable and configured to conform to the gantry guide shaft during movement of thereon.

### CROSS-REFERENCE TO RELATED APPLICATION(S)

The present application claims priority to U.S. Provisional Pat. App. No. 63/292,373, filed Dec. 21, 2021, titled ADAPTIVE WHEEL DRIVE SYSTEM FOR A LIQUID JET CUTTING SYSTEM GANTRY, and incorporated herein by reference in its entirety.

### TECHNICAL FIELD

The present technology is generally directed to liquid jet cutting systems and other material processing machines and, more particularly, to gantry drive systems and associated devices and methods for use with such machines.

### BACKGROUND

Material processing machines, such as abrasive waterjet systems and other liquid jet cutting systems, plasma arc cutting systems, laser cutting systems, etc., are used in precision cutting, shaping, carving, reaming, and other material processing applications. During operation of an abrasive waterjet system, a cutting head movably mounted to a gantry directs a high-velocity jet of liquid carrying particles of abrasive material toward a workpiece on a cutting table to rapidly erode portions of the workpiece. Abrasive waterjet processing has significant advantages over other material processing technologies (e.g., grinding, plasma-cutting, etc.). For example, abrasive waterjet systems tend to produce relatively fine and clean cuts without heat-affected zones around the cuts. Abrasive waterjet systems also tend to be highly versatile with respect to the material type of the workpiece. The range of materials that can be processed using abrasive waterjet systems includes very soft materials (e.g., rubber, foam, leather, and paper) as well as very hard materials (e.g., stone, ceramic, and hardened metal). Furthermore, in many cases, abrasive waterjet systems are capable of executing demanding material processing operations while generating relatively little or no dust, smoke, or other undesirable airborne byproducts.

Some systems use a ball screw to move the gantry over the cutting table. Other systems employ a wheel drive system to translate the gantry. In some such wheel drive systems, a set of stainless-steel wheels pinch and drive across a stainless steel shaft/rail. The wheels are often formed with a gothic arch profile to provides two points of contact between the wheels and the shaft, often at 10 o'clock and 2 o'clock relative to a cross-section of the shaft. However, contact between the wheels and the shaft may cause wear that degrades the wheels and the shaft over time, and can be exacerbated by the presence of abrasive from the material processing machine. Lubrication of the interface between the wheels and shaft can mitigate wear issues but can also cause slippage that negatively impacts the accuracy with which the gantry can be moved/positioned.

### BRIEF DESCRIPTION OF THE DRAWINGS

FIG. 1 is a partially schematic end view of a material processing machine having a gantry drive system configured in accordance with embodiments of the present technology.

FIG. 2A is an outwardly facing perspective view of a gantry carriage of the gantry drive system of FIG. 1, configured in accordance with embodiments of the present technology.

FIG. 2B is an inwardly facing perspective view of the gantry carriage of FIG. 2A, configured in accordance with embodiments of the present technology.

FIG. 3A is an enlarged, outwardly facing perspective view of a drive assembly of the gantry carriage of FIG. 2A, configured in accordance with embodiments of the present technology.

FIG. 3B is a top view of the drive assembly of FIG. 3A, configured in accordance with embodiments of the present technology.

FIG. 3C is a side cross-sectional view of the drive assembly of FIGS. 3A and 3B taken along section line 3C-3C in FIG. 3B and configured in accordance with embodiments of the present technology.

FIG. 3D is a side cross-sectional view of the drive assembly of FIGS. 3A and 3B taken along section line 3D-3D in FIG. 3B and configured in accordance with embodiments of the present technology.

FIG. 4A is an end view of a portion of the gantry carriage of FIG. 2A, configured in accordance with embodiments of the present technology.

FIG. 4B is an enlarged, side cross-sectional view of a guide wheel of the gantry carriage of FIG. 2A, configured in accordance with embodiments of the present technology.

### DETAILED DESCRIPTION

The following disclosure describes various embodiments of gantry drive systems for use with liquid jet cutting systems, plasma arc cutting systems, and/or other material processing machines. Embodiments of the gantry drive systems described herein can include first and second gantry carriages positioned at opposite ends of the gantry. Each of the gantry carriages can include a mounting structure configured to support the corresponding end of the gantry, and a drive assembly movably coupled to the mounting structure. Each of the drive assemblies can be configured to operably engage a corresponding guide shaft mounted to the respective side of the material processing machine and move the gantry back and forth along a horizontal axis. The drive assemblies can also be configured to move up and down along a vertical axis relative to their respective mounting structures. The ability of the drive assemblies to independently move up and down along the vertical axis can allow the gantry drive system to compensate for deformation, deflection, bending, and/or misalignment of the guide shafts, which is expected to improve the accuracy with which the gantry can be positioned during machine operation. In some embodiments, each of the gantry carriages further includes one or more guide wheels rotatably mounted to the mounting structure and configured to support the carriage relative to the guide shaft. In some embodiments, each of the guide wheels includes an annular outer portion having an exterior surface with a concave cross-sectional shape or curvature configured to complementarily engage the guide shaft. In some embodiments, the annular outer portion is resiliently deformable to allow the guide wheels to conform and maintain suitable contact with the guide shaft in response to variations in the relative position of the guide shaft during movement of the gantry.

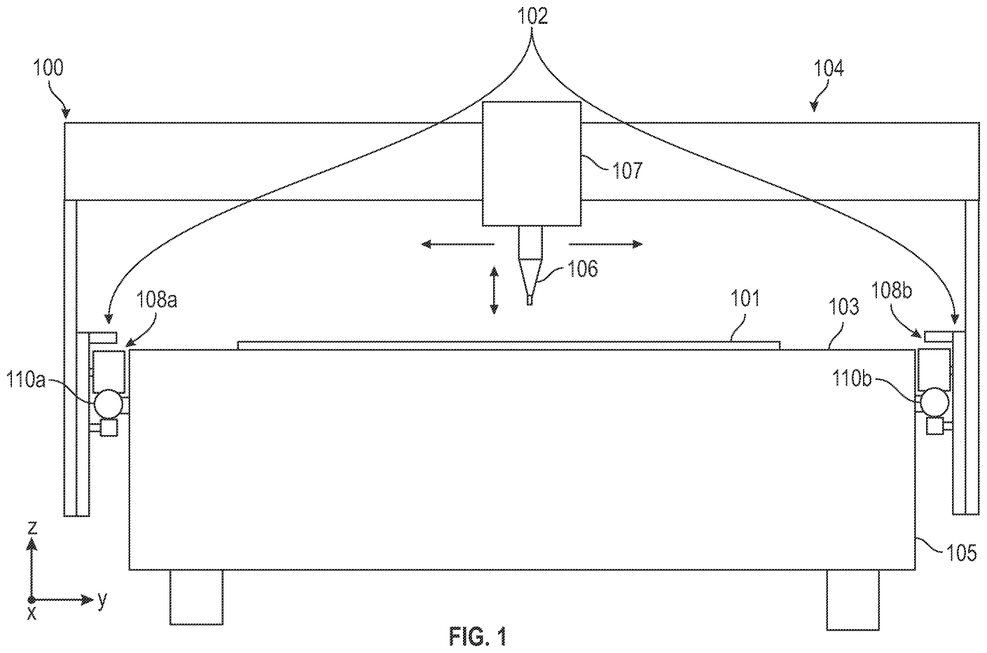

Specific details of abrasive liquid jet systems and related devices, systems, and methods in accordance with several embodiments of the present technology are disclosed herein with reference to FIGS. 1-4B. Although the devices, systems, and methods may be disclosed herein primarily or entirely with respect to certain liquid jet cutting applications, other applications in addition to those disclosed herein are within the scope of the present technology. Furthermore, it should be understood, in general, that other devices, systems, and methods, including other abrasive waterjet devices, systems, and methods, in addition to those disclosed herein are within the scope of the present technology. For example, devices, systems, and methods in accordance with embodiments of the present technology can have different and/or additional configurations, components, and procedures than those disclosed herein. Moreover, a person of ordinary skill in the art will understand that devices, systems, and methods in accordance with embodiments of the present technology may not include one or more of the configurations, components, and/or procedures disclosed herein without deviating from the present technology. Liquid jet systems configured in accordance with embodiments of the present technology can be used with a variety of suitable fluids, such as water, aqueous solutions, hydrocarbons, glycols, and nitrogen, and/or a variety of suitable abrasives, such as particulate abrasive, abrasive garnet, sand, and/or other appropriate abrasive materials or combinations thereof.

As used herein, the use of relative terminology, such as “about”, “approximately”, “substantially” and the like refer to the stated value plus or minus ten percent. For example, the use of the term “about 100” refers to a range of from 90 to 110, inclusive. In instances in which the context requires otherwise and/or relative terminology is used in reference to something that does not include a numerical value, the terms are given their ordinary meaning to one skilled in the art.

FIG. 1 is a partially schematic end view of a material processing machine 100 (“machine 100”) having a gantry drive system 102 configured in accordance with embodiments of the present technology. The machine 100 can include a cutting table 103 supported by a base 105, and a gantry 104 configured to movably support a cutting device 106 relative to the cutting table 103. In the illustrated embodiment, the gantry drive system 102 includes a first gantry carriage 108a positioned toward a first side (e.g., a left side) of the base 105 and a second gantry carriage 108b positioned toward a second side (e.g., a right side) of the base 105. Each of the gantry carriages 108 can be movably coupled to a corresponding, elongate guide shaft 110 (identified individually as a first guide shaft 110a and a second guide shaft 110b) which is fixedly attached to the adjacent side wall of the base 105. In the illustrated embodiment, the guide shafts 110 are mounted to the respective side walls of the base 105 in horizontal, parallel orientations. As described in greater detail below, the gantry carriages 108 are configured to move back and forth on the respective guide shafts 110a and 110b parallel to a first or X-axis (e.g., into and/or out of the page and/or horizontally toward the front or back of the base 105), to move the gantry 104 and the cutting device 106 during operation of the machine 100. In some embodiments, the first and second gantry carriages 108a and 108b can be configured to move in tandem, e.g., at a same rate and/or in a same direction along the X-axis without or substantially without moving relative to one another. Maintaining the relative positions of the first and second gantry carriages 108a and 108b, e.g., by reducing or eliminating movement relative to one another, can improve the accuracy with which the cutting device 106 can be positioned relative to the workpiece 101 during operation of the machine 100.

In some embodiments, the cutting device 106 is operably mounted to a cutting device carriage 107 which is in turn movably coupled to the gantry 104. The cutting device carriage 107 can be configured to move the cutting device 106 parallel to a second or Y-axis relative to the cutting table 103 (e.g., laterally and/or horizontally, toward and/or away from the left and/or right sides of the base 105). In these and other embodiments, the cutting device 106 can also be configured to move parallel to a third or Z-axis relative to the cutting table 103 (e.g., vertically, up and/or down). Accordingly, in operation the cutting device 106 can be moved along the X-, Y-, and/or Z-axes relative to the workpiece 101, such as along a planned cut path used to machine, cut, and/or otherwise manufacture one or more components from the workpiece 101. In some embodiments, the cutting device 106 can be a liquid jet cutting head configured to direct high-pressure liquid (e.g., water) and/or abrasive (e.g., garnet) toward the workpiece 101. Accordingly, in at least some embodiments the machine 100 is a liquid-jet cutting system. In other embodiments, the machine 100 can be a plasma, laser, or other type of material cutting, shaping, and/or welding system. In yet further embodiments, the machine 100 can be other types of material processing machines having a movable gantry to support other types of material processing tools and devices.

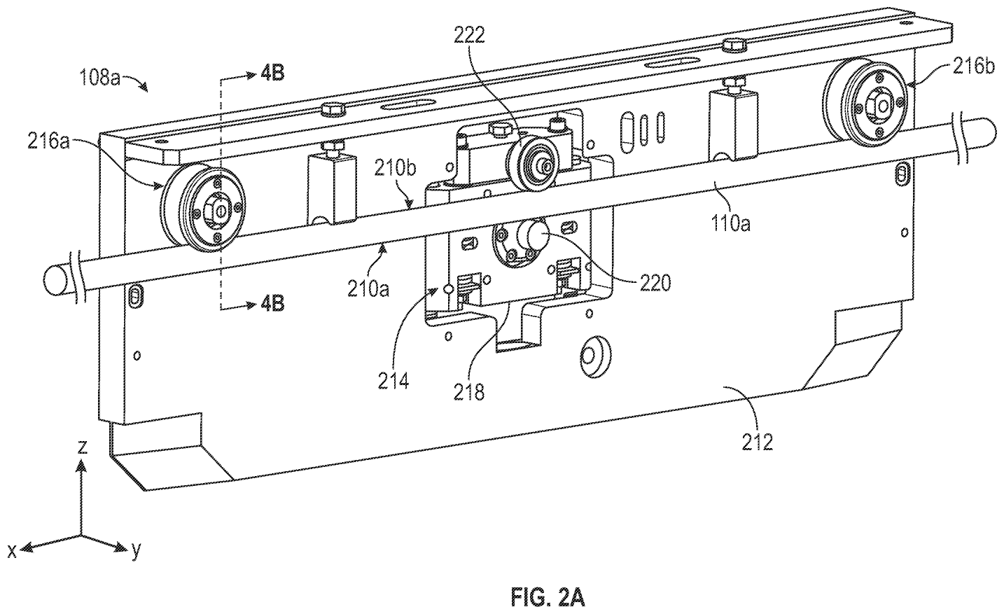

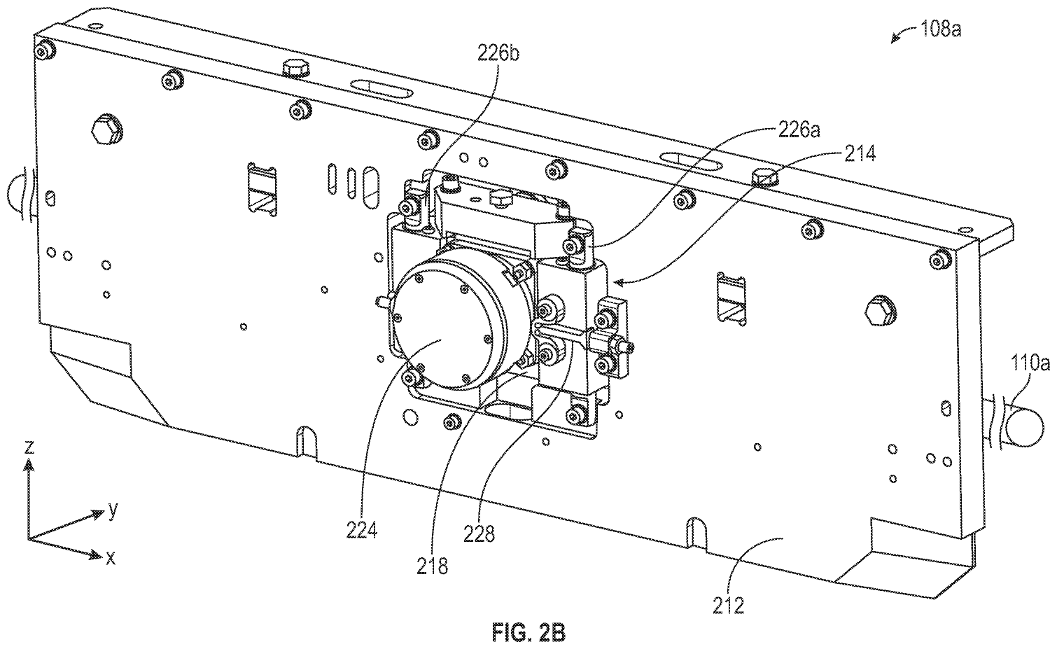

FIG. 2A is an outwardly facing perspective view of the first gantry carriage 108a of the gantry drive system 102, configured in accordance with embodiments of the present technology. The first gantry carriage 108a can include a mounting structure 212 and a drive assembly 214. The mounting structure 212 can be coupled to and/or configured to support one end portion (e.g., the left end portion) of the gantry 104 (FIG. 1). In some embodiments, the mounting structure 212 includes one or more guide wheels 216 (individually identified as a first guide wheel 216a and a second guide wheel 216b) configured to at least partially couple the mounting structure 212 to the first guide shaft 110a. In the illustrated embodiment, the first guide wheel 216a is positioned toward a first (e.g., left or front) side of the drive assembly 214 and the second guide wheel 216b is positioned toward a second (e.g., right or rear) side of the drive assembly 214 opposite the first side. In other embodiments, the mounting structure 212 can include a greater or lesser number of guide wheels 216, and/or guide wheels 216 having other suitable positions relative to the drive assembly 214.

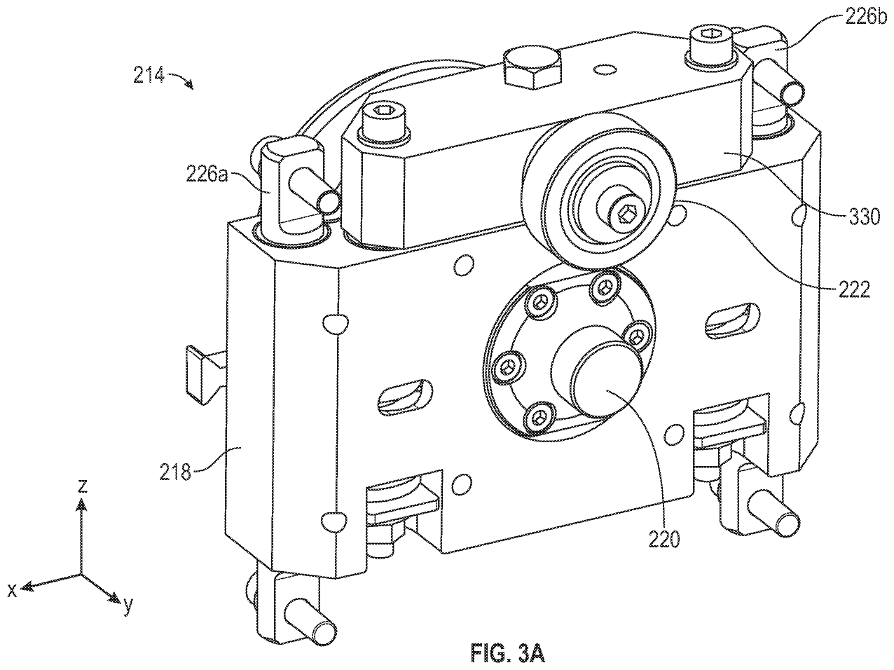

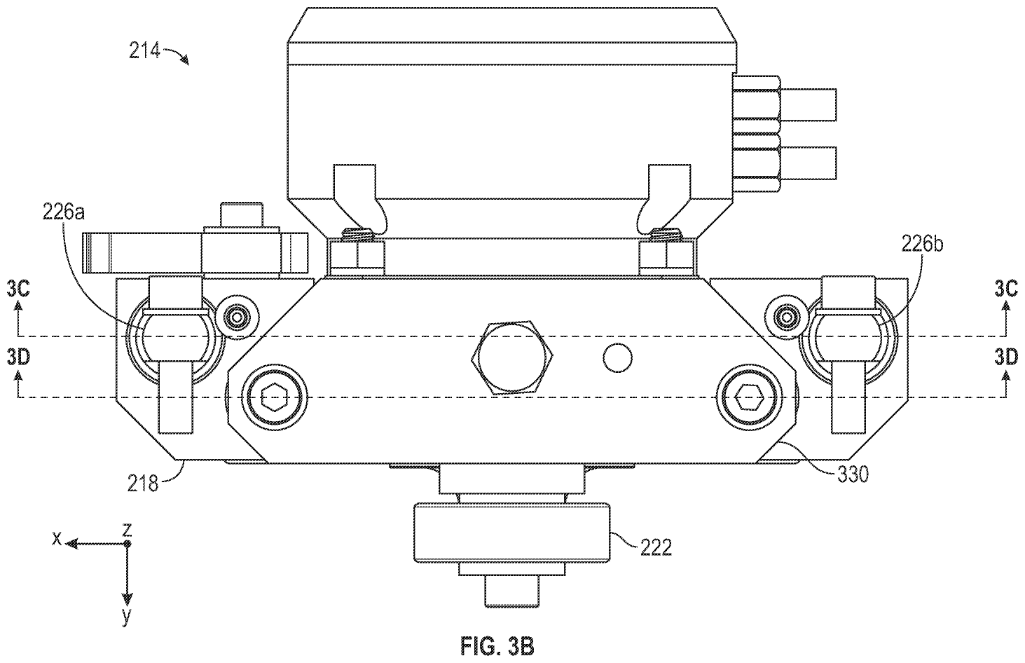

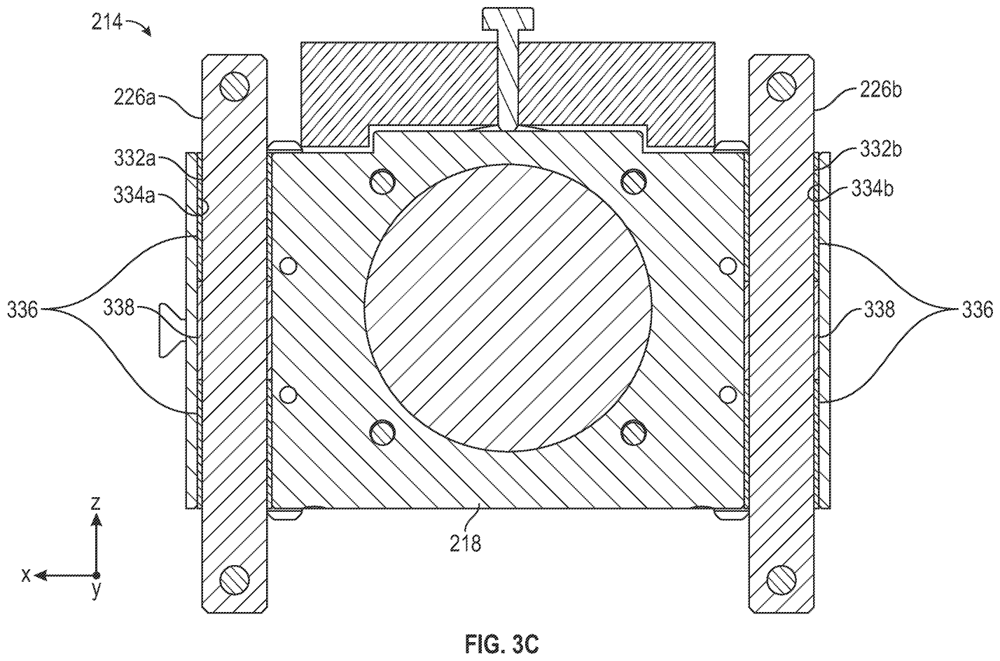

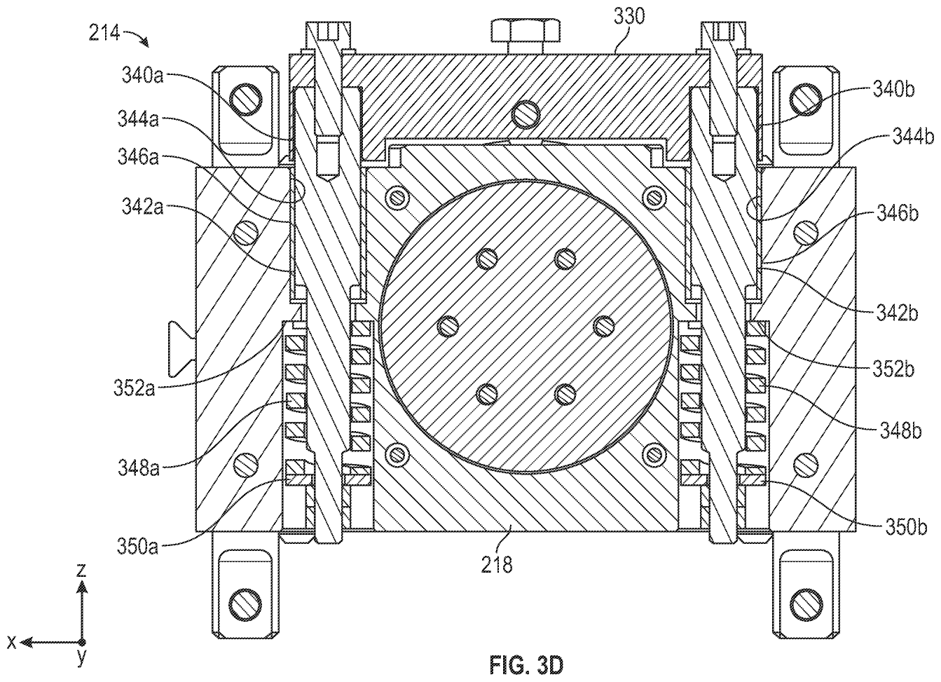

In the illustrated embodiment, the drive assembly 214 can include a chassis 218 operably coupled to the mounting structure 212, a first or drive wheel 220 configured to contact a first side portion 210a (e.g., a lower side portion) of the guide shaft 110a, and a second or pinch wheel 222 configured to contact a second side portion 210b (e.g., an upper side portion) of the guide shaft 110a. The second side portion 210b can be opposite, or at least substantially opposite, to the first side portion 210a, and accordingly the pinch wheel 222 can be positioned opposite, or at least substantially opposite, to the drive wheel 220. As described in greater detail below with reference to FIGS. 3A-3D, the pinch wheel 222 can be biased toward the drive wheel 220, e.g., to pinch or press the guide shaft 110a between the drive wheel 220 and the pinch wheel 222 and hold the drive wheel 220 in operational contact with the first guide shaft 110a. In some embodiments, one or both of the guide wheels 216a and 216b can be positioned against the second side portion 210b of the guide shaft 110a, such that the drive wheel 220 can be positioned opposite, or at least substantially opposite, one or both of the guide wheels 216.

FIG. 2B is an inwardly facing perspective view of the first gantry carriage 108a, configured in accordance with embodiments of the present technology. The drive assembly 214 can further include a motor 224 (e.g., an electric motor, an internal combustion motor, a pneumatic motor, etc.) operably coupled to the chassis 218. The motor 224 can include a drive shaft (not shown) extending outwardly therefrom and fixedly coupled to the drive wheel 220 (FIG. 2A). The motor 224 can be configured to rotate the drive shaft in two directions (e.g., the clockwise direction and the counterclockwise direction). In operation, rotation of the drive shaft in the first direction rotates the drive wheel 220 in the first direction and thereby moves the gantry carriage 108a in a first horizontal direction (e.g., rearwardly) along the guide shaft 110a (FIG. 2A) parallel to the X axis. Similarly, rotation of the drive shaft in the second direction rotates the drive wheel 220 in the second direction and thereby moves the gantry carriage 108a in a second horizontal direction (e.g., forwardly) along the guide shaft 110a parallel to the X-axis.

In some embodiments, the drive assembly 214 can further include one or more chassis guides 226 (identified individually as a first chassis guide 226a and a second chassis guide 226b). In the illustrated embodiment, the first chassis guide 226a is positioned toward a first side of the motor 224 and the second chassis guide 226b is positioned parallel to the first chassis guide 226a and toward a second side of the motor 224 opposite the first side. The chassis guides 226 can be vertically oriented, e.g., in a direction parallel to the Z-axis and fixedly attached to the mounting structure 212 by, e.g., one or more fasteners extending through upper and lower end portions thereof. The chassis 218 can be slidably coupled to the chassis guides 226, such that the chassis 218 can float, shift, and/or otherwise move vertically along the chassis guides 226 (e.g., up and/or down parallel to the Z-axis) relative to the mounting structure 212.

Because the gantry 104 (FIG. 1) is attached (e.g., bolted) to the mounting structure 212, unintended motion of the mounting structure 212, e.g., in response to deformation, bending, misalignment, etc. of the guide shaft 110a (FIG. 2A), could cause the cutting device 106 to move or otherwise deviate from a planned cut path and introduce errors into the machining of the workpiece 101 (FIG. 1). Accordingly, enabling the chassis 218 to move vertically up and down (e.g. “float”) relative to the mounting structure 212 in response to, e.g., deformation, bending, misalignment, etc. of the guide shaft 110a is expected to reduce or prevent deviations in planned cut paths and/or machining errors by allowing the drive assembly 214 to compensate for such variations in the guide shaft 110a and thereby reduce or prevent unintended motion of the mounting structure 212. In other embodiments, the drive assembly 214 can include a greater or lesser number of the chassis guides 226, and/or the chassis guides 226 at other suitable positions.

In some embodiments, the chassis guides 226 can be configured to reduce or prevent other, non-vertical movement of the chassis 218 relative to the mounting structure 212, e.g., parallel to the X and/or Y-axes. This, in turn, can reduce or prevent, e.g., non-vertical movement of the first gantry carriage 108a relative to the second gantry carriage 108b (FIG. 1) during movement of the gantry 104. As described previously with reference to FIG. 1, movement of the first gantry carriage 108a and the second gantry carriage 108b relative to one another can cause the gantry 104 (FIG. 1) to “crab-walk” (e.g., rotate relative to the base 105 (FIG. 1) while moving along the guide shafts 110) and/or may decrease the accuracy with which the cutting device 106 can be positioned relative to the workpiece 101 (FIG. 1). Accordingly, reducing or preventing other, non-vertical movement of the chassis 218 relative to the mounting structure 212 (e.g., parallel to the X and/or Y axes) can improve the accuracy with which the cutting device 106 can be positioned relative to the workpiece 101 during operation of the machine 100.

In some embodiments, the gantry carriage 108a can include an elongate flexure connection 228 coupling at least a portion of the drive assembly 214 (e.g., the chassis 218) to the mounting structure 212 to at least partially prevent or resist some movement (e.g., vertical movement) of the drive assembly 214 relative to the mounting structure 212 from, e.g., misalignment of the guide shaft 110a. For example, in some embodiments the flexure connection 228 can limit movement of the drive assembly 214 relative to the mounting structure 212, such that external forces on the drive assembly 214 do not cause appreciable movement of the drive assembly 214 relative to the mounting structure 212. In other embodiments, the flexure connection can be omitted.

Although FIGS. 2A and 2B are described above with reference to the first gantry carriage 108a, it will be appreciated that the second gantry carriage 108b (FIG. 1) can be the same in structure and/or function, or at least generally similar or identical in structure and/or function, to the first gantry carriage 108a, but can be configured to operably engage the second guide shaft 110b (FIG. 1) instead of the first guide shaft 110a.

FIG. 3A is an outwardly facing perspective view of the drive assembly 214, and FIG. 3B is a top view of the drive assembly 214, configured in accordance with embodiments of the present technology. Referring to FIGS. 3A and 3B together, in some embodiments pinch wheel 222 is rotatably mounted to a wheel carrier 330 positioned at least partially or fully between the chassis guides 226a and 226b. As described in greater detail below with reference to FIG. 3D, the wheel carrier 330 can be biased toward the chassis 218 but configured to have limited vertical travel (e.g., parallel to the Z-axis) relative to the chassis 218.

FIG. 3C is a side cross-sectional view of the drive assembly 214 taken along section line 3C-3C in FIG. 3B. In some embodiments, each of the chassis guides 226a and 226b includes a corresponding shaft portion 332 (identified individually as a first shaft portion 332a and a second shaft portion 332b) which is slidably received in a corresponding chassis guide bore 334 (identified individually as a first chassis guide bore 334a and a second chassis guide bore 334b) in the chassis 218 to movably mount the chassis 218 to the mounting structure 212. In some embodiments, one or more bearings 336 can be firmly positioned in each chassis guide bore 334a and 334b and configured to snugly but slidably receive the corresponding shaft portion 332. The bearings 336 can include sleeve bearings, bushings, or other suitable bearings formed of, e.g., stainless steel, phosphor bronze, and/or other suitable bearing materials, and can be configured to facilitate the vertical movement of the chassis 218 along the shaft portions 332. In the illustrated embodiment, two bearings 336 are positioned in each of the chassis guide bores 334. In other embodiments a greater or lesser number of bearings 336 can be positioned around each of the chassis shaft portions 332, or the bearings 336 can be omitted. In some embodiments, one or more spacers 338 can be positioned in the bores 334 and between individual ones of the bearings 336.

FIG. 3D is a side cross-sectional view of the drive assembly 214 taken along section line 3D-3D in FIG. 3B. In the illustrated embodiment, the wheel carrier 330 includes a first carrier guide 340a and a second carrier guide 340b extending downwardly therefrom. Each of the carrier guides 340 can include a corresponding shaft portion 342 (identified individually as a first shaft portion 342a and a second shaft portion 342b) configured to be slidably received in a corresponding carrier guide bore 344 (identified individually as a first carrier guide bore 344a and a second carrier guide bore 344b) in the chassis 218 to moveably couple the wheel carrier 330 to the chassis 218. In the illustrated embodiment, for example, at least part of the first shaft portion 342a is positioned within the first carrier guide bore 344a and at least part of the second shaft portion 342b is positioned within the second carrier guide bore 344b. The carrier guide bores 344 can extend through the chassis 218 to allow the wheel carrier 330 to move (e.g., vertically and parallel to the Z-axis) relative to the chassis 218. In some embodiments, one or more bearings 346 (identified individually as a first bearing 346a and a second bearing 346b) can be firmly positioned in each of the guide bores 344a and 344b and configured to slidably receive the corresponding carrier guide shaft portion 342. The bearings 346 can include sleeve bearings, bushings, or other suitable bearings, and can be configured to facilitate the movement (e.g., vertical movement) of the wheel carrier 330 relative to the chassis 218.

In some embodiments, the drive assembly 214 can further include a first biasing element 348a and a second biasing element 348b configured to resiliently bias the wheel carrier 330 and the chassis 218 toward each other in a direction parallel to the Z-axis. Biasing the wheel carrier 330 and the chassis 218 toward each other in this manner biases the pinch wheel 222 and the drive wheel 220 (FIG. 3A) toward each other so that the pinch wheel 222 and the drive wheel 220 press the guide shaft 110a (FIGS. 1-2B) therebetween and the drive wheel 220 exerts sufficient pressure against the guide shaft 110a to avoid slippage between the drive wheel 220 and the guide shaft 110a during operation of the motor 224. In some embodiments, the biasing elements 348 can be positioned to bias the wheel carrier 330 toward the chassis 218 and parallel to the Z-axis without or substantially without applying forces to the wheel carrier 330 parallel to the X or Y-axes, which is expected to prevent, or at least partially prevent, crab-walking of the gantry 104 (FIG. 1). In some embodiments, the biasing elements 348 can be positioned to act against the carrier guide shaft portions 342. For example, the biasing elements 348 can be positioned within the corresponding guide bores 344, around the corresponding guide shafts 342, and compressed between a corresponding end cap or washer 350 (individually identified as a first washer 350a and a second washer 350b) coupled to a distal end portion of the respective guide shaft portion 342 and a corresponding annular flange or tab 352 (individually identified as a first tab 352a and a second tab 352b) positioned within the respective guide bore 344. In other embodiments, the biasing elements 348 can be positioned to act directly against the wheel carrier 330 and/or another suitable portion of the drive assembly 214. The biasing elements 348 can include one or more compression springs (e.g., helical coil springs), tension springs, torsion springs, pneumatic cylinders, hydraulic cylinders, solenoids, motors, and/or any other suitable biasing element. The biasing elements 348 can have a sufficient spring constant and/or apply sufficient force to ensure that the wheel carrier 330 presses the pinch wheel 222 (FIG. 2A) against the guide shaft 110a (FIG. 2A) toward and/or into contact with the drive wheel 220 (FIG. 2A), e.g., to create and/or maintain operable engagement between the drive wheel 220 and the guide shaft 110a. For example, the biasing elements 348 can be configured to apply an adjustable force (e.g., a clamping force) from between about 0.01G to about 0.1G, or between about 0.01G to about 0.05 G, e.g., about 0.037G, which is expected to improve traction of the drive wheel 220 on the first gantry guide shaft 110a by reducing or preventing the drive wheel 220 from slipping when rotated relative to the first gantry guide shaft 110a. In some embodiments, a user can adjust (e.g., increase or decrease) the biasing force provided by individual ones of the biasing elements 348. For example, the user can decrease a space between individual ones of the washers 350 and the tabs 352 to further compress the biasing elements 348 and increase the force with which the wheel carrier 330 and the chassis 218 are resiliently biased toward each other. As another example, the user can increase the space between the washers 350 and the tabs 352 to allow the biasing elements 348 to lengthen and decrease the force with which the wheel carrier 330 and the chassis 218 are biased toward each other.

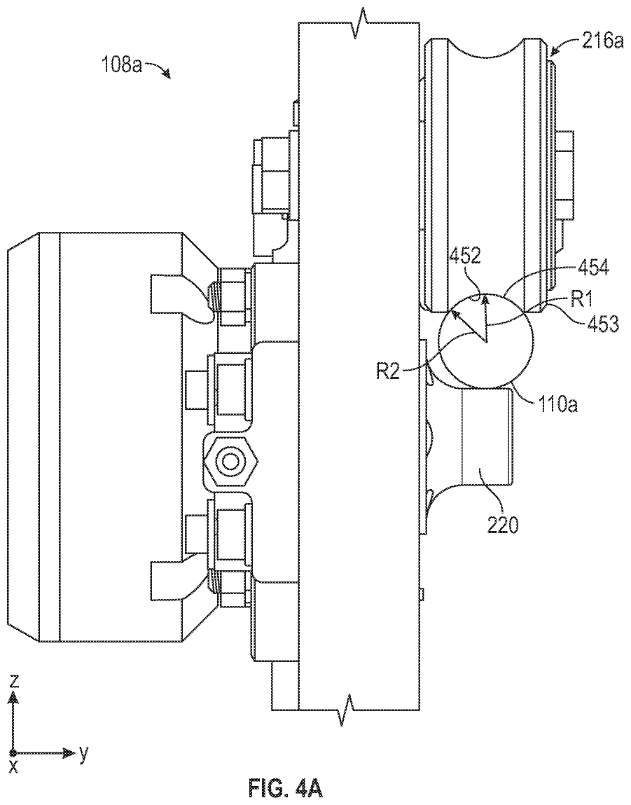

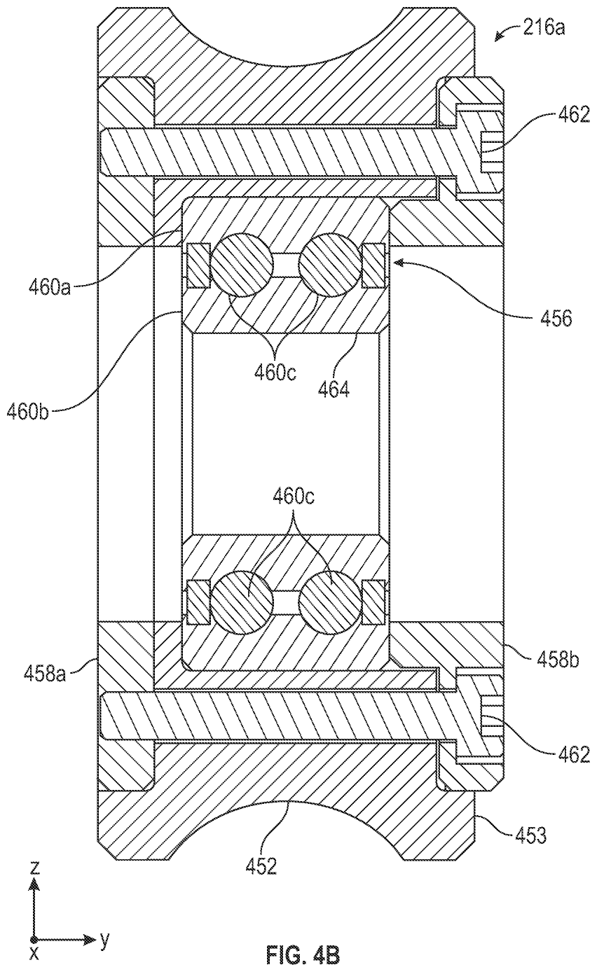

FIG. 4A is an enlarged end view of a portion of the gantry carriage 108a of FIG. 2A configured in accordance with embodiments of the present technology. In the illustrated embodiment, the first guide wheel 216a can include an annular outer portion 453 configured to contact the gantry guide shaft 110a. In some embodiments, the annular outer portion 453 includes an annular outer surface portion 452 having a curved or arcuate cross-sectional profile configured to match and/or complementarily engage, or otherwise correspond to a cross-sectional curvature (e.g., a cross-sectional radius of curvature) of the gantry guide shaft 110a. For example, the gantry guide shaft 110a can include an outer surface portion 454 having a convex cross-sectional shape (e.g., a circular cross-sectional shape), and the outer surface portion 452 of the first guide wheel 216a can have a corresponding concave cross-sectional shape (e.g., a circular arc shape) that is at least substantially complementary to or the mirror image of the convex cross-sectional shape of the outer surface portion 454 of the guide shaft 110a. For example, in some embodiments the convex cross-sectional shape of the outer surface portion 454 can have a first radius of curvature R1 and the concave cross-sectional shape of the outer surface portion 452 of the guide wheel 216a can have a second radius of curvature R2 that is at least approximately equal to, or equal to, the first radius of curvature R1. In some embodiments, the annular outer surface portion 452 is contoured to match the outer surface portion 454. In these and other embodiments, by having complementary shapes the outer surface portion 452 can be configured to maintain more than two points of contact between the guide wheel 216a and the gantry guide shaft 110a. Without being bound by theory, the complementary curvature of the outer surface portion 452 is expected to increase a contact surface area between the guide wheel 216a and the gantry guide shaft 110a, which is in turn expected to reduce or eliminate unintentional movement (e.g., lateral movement along the Y-axis) of the guide wheel 216a relative to the gantry guide shaft 110a and/or reduce wear on the gantry guide shaft 110a from movement of the guide wheel 216a.

In some embodiments, the outer surface portion 452 of the guide wheel 216a can be configured to conformably contact the outer surface portion 454 of the guide shaft 110 during operation of the gantry carriage 108a (FIG. 1). For example, the outer surface portion 452 can be configured to resiliently and/or elastically deform to conform to the curvature of the outer surface portion 454 of the guide shaft 110a. For example, in some embodiments the annular outer portion 453 can be made from and/or otherwise include a resilient material such as an acetal homopolymer, polyoxymethylene, Delrin®, rubber, and/or other suitable materials. Additionally or alternatively, by way of example, the annular outer portion 453 can have a flexural modulus of between about 400,000 psi and about 500,000 psi, a compressive modulus of between about 400,000 psi and about 500,000 psi, a flexural strength of between about 10,000 psi and about 15,000 psi, a compressive strength of between about 14,000 psi and about 18,000 psi, and/or any material property values therebetween and/or combinations thereof, and/or other suitable material property values. In at least some embodiments, for example, the annular outer portion 453 has a flexural modulus of about 450,000 psi, a compressive modulus of about 450,000 psi, a flexural strength of about 13,000 psi, and/or a compressive strength of about 16,000 psi, and/or any sub-combinations thereof. In these and other embodiments, the deformability (e.g., the resilient, or at least partially resilient, deformability) of the annular outer portion 453 is expected to allow the guide wheel 216a to self-correct and/or reshape itself over time, including during operation of the gantry carriage 108a. For example, in some embodiments the annular outer portion 453 may flatten or deform out of complementarity with the gantry guide shaft 110a after periods during which the gantry carriage 108a is stationary relative to the gantry guide shaft 110a. This flattening/deformation could otherwise lead to unwanted motion (e.g., lateral shifting) of the gantry carriage 108a relative to the guide shaft 110a in operation. However, because of the resilient/elastic nature of the annular outer portion 453, movement of the guide wheel 216a along the gantry guide shaft 110a can correct or reshape the curvature of the outer surface portion 452 back toward and/or into a complementary shape with the curvature of the gantry guide shaft 110a. Accordingly, at least compared to conventional guide wheels that can experience permanent wear and/or deformation (e.g., plastic deformation) during use, guide wheels (e.g., the guide wheels 216a and 216b) configured in accordance with embodiments of the present technology are expected to have increased resilience to wear at least because of the self-correcting properties of the annular outer portion 453. Additionally or alternatively, the deformability of the annular outer portion 453 can reduce or prevent wear on the gantry guide shaft 110a, without or substantially without the use of lubricants or other wear-reducing measures. In other embodiments the guide wheels 216 can have different shapes and/or configurations. Accordingly, embodiments of the present technology are not limited to the guide wheels 216 illustrated in FIG. 4A. In at least some embodiments the guide wheels 216 can be omitted.

FIG. 4B is an enlarged side cross-sectional view of the first guide wheel 216a configured in accordance with embodiments of the present technology. The guide wheel 216a can further include a bearing assembly 456 and one or more retaining plates 458 (individually identified as a first retaining plate 458a and a second retaining plate 458b in FIG. 4B). The bearing assembly 456 can include an outer portion 460a (e.g., an outer race), an inner portion 460b (e.g., an inner race), and one or more bearings 460c positioned therebetween. The bearings 460c can include ball bearings or other suitable bearings. The inner portion 460b can include a central cylindrical bore 464 through which the guide wheel 216a can be coupled to the mounting structure 212 (FIG. 4A). In some embodiments, the retaining plates 458 can be configured to couple the annular outer portion 453 to the bearing assembly 456. In the illustrated embodiment, for example, the first retaining plate 458a and the second retaining plate 458b are positioned on opposing (e.g., left and right) sides of the annular outer portion 453 and the bearing assembly 456 and coupled to one another via one or more fasteners 462 that extend at least partially through the annular outer portion 453. The fasteners 462 can include one or more screws, bolts, rivets, and/or other suitable fasteners. Additionally or alternatively, the annular outer portion 453 can be adhered (e.g., adhesively bonded) to the outer portion 460a of the bearing assembly 456. The inner portion 460b of the bearing assembly 456 can be held stationary relative to the annular outer portion 453 and the outer bearing portion 460b such that the annular outer portion 453 can rotate freely relative to the inner portion 460b.

Although FIGS. 4A and 4B are described with reference to the first guide wheel 216a, it will be appreciated that the second guide wheel 216b can be at least generally similar or identical in structure and/or function to the first guide wheel 216a.

### EXAMPLES

Several aspects of the present technology are described with reference to the following examples:
1. A system for moving a gantry on a material processing machine, the system comprising:
a mounting structure configured to be operably coupled to the gantry; and
a drive assembly, the drive assembly including—
   a chassis operably coupled to the mounting structure;
   a motor operably mounted to the chassis;
   a first wheel drivably coupled to the motor and configured to contact a first side of a gantry guide shaft; and
   a second wheel operably mounted to the chassis and configured to contact a second side of the gantry guide shaft substantially opposite the first side,
   wherein—
      at least one of the first wheel or the second wheel is biased toward the other of the first wheel or the second wheel to press the gantry guide shaft therebetween,
      the motor is configured to drive the first wheel to move the mounting structure in a first direction relative to the gantry guide shaft, and
      the chassis is configured to move in a second direction, perpendicular to the first direction, relative to the mounting structure.
2. The system of example 1 wherein the chassis is configured to float in the second direction relative to the mounting structure.
3. The system of example 1 or example 2 wherein the second wheel is configured to move in the second direction independently of the first wheel.
4. The system of any of examples 1-3 wherein the motor is configured to drive the first wheel to move the mounting structure back and forth in a horizontal direction relative to the gantry guide shaft, and wherein the chassis is configured to move up and down in a vertical direction relative to the mounting structure.
5. The system of any of examples 1-4 wherein the drive assembly further includes one or more chassis guides coupled to the mounting structure, and wherein the chassis is movably mounted to the one or more chassis guides.
6. The system of example 5 wherein the one or more chassis guides include a first chassis guide positioned on a first side of the motor and a second chassis guide positioned on a second side of the motor, opposite the first side.
7. The system of example 6 wherein the chassis define a first chassis guide bore configured to slidably receive the first chassis guide and a second chassis guide bore configured to slidably receive the second chassis guide.
8. The system of example 6 or example 7 wherein the first chassis guide includes a first chassis guide shaft and the second chassis guide includes a second chassis guide shaft, and wherein the chassis is slidably mounted to the first and second chassis guide shafts.
9. The system of any of examples 1-8 wherein the drive assembly further includes a wheel carrier movably coupled to the chassis, wherein the second wheel is rotatably mounted to the wheel carrier.
10. The system of example 9 wherein the wheel carrier includes one or more carrier guides, and wherein the chassis includes one or more carrier guide bores configured to movably receive the one or more carrier guides.
11. The system of example 9 or example 10 wherein the wheel carrier includes one or more carrier guide shafts, and wherein the one or more carrier guide bores are configured to slidably receive the one or more carrier guide shafts.
12. The system of example 11 wherein the one or more carrier guide shafts include a first carrier guide shaft and a second carrier guide shaft spaced apart from the first carrier guide shaft, wherein the one or more carrier guide bores include a first carrier guide bore positioned on a first side of the motor and a second carrier guide bore positioned on a second side of the motor, opposite the first side, and wherein the first carrier guide bore is configured to slidably receive the first carrier guide shaft and the second carrier guide bore is configured to slidably receive the second carrier guide shaft.
13. The system of any of examples 9-12 wherein the chassis further includes a biasing member configured to bias the wheel carrier toward the motor.
14. The system of example 13 wherein the biasing member includes a coil spring.
15. The system of any of examples 1-14 wherein the gantry carries a cutting device.
16. The system of any of examples 1-15 wherein the gantry carries a liquid jet cutting head.
17. A gantry carriage for use with a material processing machine having a guide shaft, the gantry carriage comprising:
a mounting structure;
a motor operably coupled to the mounting structure;
a drive wheel operably coupled to the motor and configured to movably engage the guide shaft to move the mounting structure relative to the guide shaft in response to operation of the motor; and
one or more guide wheels rotatably coupled to the mounting structure, wherein the guide shaft has an outer surface portion with a convex cross-sectional shape, wherein each of the one or more guide wheels has an annular outer portion with a concave cross-sectional shape, and wherein the concave cross-sectional shape is substantially complementary to the convex cross-sectional shape.
18. The gantry carriage of example 17 wherein the convex cross-sectional shape has a first radius of curvature, and wherein the concave cross-sectional shape has a second radius of curvature that is the same as the first radius of curvature.
19. The gantry carriage of example 17 or example 18 wherein the one or more guide wheels include a first guide wheel and a second guide wheel spaced apart from the first guide wheel, and wherein the first and second guidewheels are configured to contact a same side of the guide shaft.
20. The gantry carriage of any of examples 17-19 wherein the one or more guide wheels include a first guide wheel positioned on a first side of the motor and a second guide wheel positioned on a second side of the motor, opposite the first side.
21. The gantry carriage of any of examples 17-20 wherein the annular outer portion of each of the one or more guide wheels is configured to conformably contact the outer surface portion of the guide shaft.
22. The gantry carriage of any of examples 17-21 wherein the annular outer portion includes at least one of an acetal homopolymer, polyoxymethylene, and/or Delrin.
23. The gantry carriage of any of examples 17-22 wherein the annular outer portion has a flexural modulus of between about 400,000 psi and about 500,000 psi.
24. The gantry carriage of any of examples 17-23 wherein the annular outer portion has a compressive modulus of between about 400,000 psi and about 500,000 psi.
25. The gantry carriage of any of examples 17-24 wherein the material processing machine further includes a cutting head movably mounted to a gantry, and wherein the mounting structure is configured to support the gantry.
26. A material processing machine, comprising:
a cutting head;
a cutting table configured to support a workpiece relative to the cutting head;
a guide shaft adjacent the cutting table; and
a drive system configured to move the cutting head relative to the cutting table, wherein the drive system includes—
   a mounting structure;
   a motor operably coupled to the mounting structure;
   a drive wheel drivably coupled to the motor and configured to contact a first side of the guide shaft, wherein the motor is configured to rotate the drive wheel to cause the mounting structure to move along the guide shaft;
   a pinch wheel configured to contact a second side of the guide shaft opposite the first side;
   a biasing member configured to bias at least one of the pinch wheel or the guide wheel toward the other of the pinch wheel or the drive wheel to drivably engage the guide shaft therebetween; and
   a guide wheel spaced apart from the motor and rotatably coupled to the mounting structure, wherein the guide wheel is configured to contact the second side of the guide shaft.
27. The material processing machine of example 26 wherein the motor is configured to (i) move the mounting structure along a first axis parallel to the guide shaft, and to (ii) move relative to the mounting structure and along a second axis, different than the first axis.
28. The material processing machine of example 27 wherein the second axis is perpendicular to the first axis.
29. The material processing machine of example 27 or example 28 wherein the first axis is a horizontal axis and wherein the second axis is a vertical axis.
30. The material processing machine of any of examples 26-29, further comprising a motor guide shaft configured to movably couple the motor to the mounting structure and allow the motor to move along a length of the motor guide shaft relative to the mounting structure.
31. The material processing machine of any of examples 26-30 wherein the drive system enables the motor to resiliently maintain vertical alignment with the guide shaft.
32. The material processing machine of any of examples 26-31 wherein the guide shaft has an outer surface portion with a convex curvature, and wherein the guide wheel has an annular outer portion with a concave curvature configured to complementarily engage the convex curvature.
33. The material processing machine of example 32 wherein the concave curvature of the guide wheel has a same radius of curvature as the convex curvature of the guide shaft.
34. The material processing machine of example 33 wherein the annular outer portion of the guide wheel is configured to resiliently deform to conform to the outer surface portion of the guide shaft.
35. The material processing machine of example 34 wherein the annular outer portion of the guide wheel includes at least one of an acetal homopolymer, polyoxymethylene, and/or Delrin.

This disclosure is not intended to be exhaustive or to limit the present technology to the precise forms disclosed herein. Although specific embodiments are disclosed herein for illustrative purposes, various equivalent modifications are possible without deviating from the present technology, as those of ordinary skill in the relevant art will recognize. In some cases, well-known structures and functions have not been shown and/or described in detail to avoid unnecessarily obscuring the description of the embodiments of the present technology. Although steps of methods may be presented herein in a particular order, in alternative embodiments the steps may have another suitable order. Similarly, certain aspects of the present technology disclosed in the context of particular embodiments can be combined or eliminated in other embodiments. Furthermore, while advantages associated with certain embodiments may have been disclosed in the context of those embodiments, other embodiments may also exhibit such advantages, and not all embodiments need necessarily exhibit such advantages or other advantages disclosed herein to fall within the scope of the present technology.

Certain aspects of the present technology may take the form of computer-executable instructions, which can be executed by one or more processors. In some embodiments, the one or more processors are specifically programmed, configured, or constructed to perform one or more of these computer-executable instructions. Furthermore, some aspects of the present technology may take the form of data (e.g., non-transitory data) stored on memory or stored or distributed on other non-transitory computer-readable media, including magnetic or optically readable or removable computer discs as well as media distributed electronically over networks. Accordingly, data structures and transmissions of data particular to aspects of the present technology are encompassed within the scope of the present technology. The present technology also encompasses methods of both programming computer-readable media to perform particular steps and executing the steps.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the terms “comprising” and the like may be used herein to mean including at least the recited feature(s) such that any greater number of the same feature(s) and/or one or more additional types of features are not precluded. Directional terms, such as “upper,” “lower,” “front,” “back,” “vertical,” and “horizontal,” may be used herein to express and clarify the relationship between various elements. It should be understood that such terms do not denote absolute orientation. Reference herein to “one embodiment,” “an embodiment,” or similar formulations means that a particular feature, structure, operation, or characteristic described in connection with the embodiment can be included in at least one embodiment of the present technology. Thus, the appearances of such phrases or formulations herein are not all referring to the same embodiment. Furthermore, various particular features, structures, operations, or characteristics may be combined in any suitable manner in one or more embodiments of the present technology.

I/we claim:

1. A system for moving a gantry on a material processing machine, the system comprising:
a mounting structure configured to be operably coupled to the gantry; and
a drive assembly, the drive assembly including—
a chassis operably coupled to the mounting structure;
a motor operably mounted to the chassis;
a first wheel drivably coupled to the motor and configured to contact a first side of a gantry guide shaft; and
a second wheel operably mounted to the chassis and configured to contact a second side of the gantry guide shaft substantially opposite the first side,
wherein—
at least one of the first wheel or the second wheel is biased toward the other of the first wheel or the second wheel to press the gantry guide shaft therebetween,
the motor is configured to drive the first wheel to move the mounting structure in a first direction relative to the gantry guide shaft, and
the chassis is configured to move in a second direction, perpendicular to the first direction, relative to the mounting structure.

2. The system of claim 1 wherein the chassis is configured to float in the second direction relative to the mounting structure.

3. The system of claim 1 wherein the second wheel is configured to move in the second direction independently of the first wheel.

4. The system of claim 1 wherein the motor is configured to drive the first wheel to move the mounting structure back and forth in a horizontal direction relative to the gantry guide shaft, and wherein the chassis is configured to move up and down in a vertical direction relative to the mounting structure.

5. The system of claim 1 wherein the drive assembly further includes one or more chassis guides coupled to the mounting structure, and wherein the chassis is movably mounted to the one or more chassis guides.

6. The system of claim 5 wherein the one or more chassis guides include a first chassis guide positioned on a first side of the motor and a second chassis guide positioned on a second side of the motor, opposite the first side.

7. The system of claim 6 wherein the chassis define a first chassis guide bore configured to slidably receive the first chassis guide and a second chassis guide bore configured to slidably receive the second chassis guide.

8. The system of claim 6 wherein the first chassis guide includes a first chassis guide shaft and the second chassis guide includes a second chassis guide shaft, and wherein the chassis is slidably mounted to the first and second chassis guide shafts.

9. The system of claim 1 wherein the drive assembly further includes a wheel carrier movably coupled to the chassis, wherein the second wheel is rotatably mounted to the wheel carrier.

10. The system of claim 9 wherein the wheel carrier includes one or more carrier guides, and wherein the chassis includes one or more carrier guide bores configured to movably receive the one or more carrier guides.

11. The system of claim 9 wherein the wheel carrier includes one or more carrier guide shafts, and wherein the one or more carrier guide bores are configured to slidably receive the one or more carrier guide shafts.

12. The system of claim 11 wherein the one or more carrier guide shafts include a first carrier guide shaft and a second carrier guide shaft spaced apart from the first carrier guide shaft, wherein the one or more carrier guide bores include a first carrier guide bore positioned on a first side of the motor and a second carrier guide bore positioned on a second side of the motor, opposite the first side, and wherein the first carrier guide bore is configured to slidably receive the first carrier guide shaft and the second carrier guide bore is configured to slidably receive the second carrier guide shaft.

13. The system of claim 9 wherein the chassis further includes a biasing member configured to bias the wheel carrier toward the motor.

14. The system of claim 13 wherein the biasing member includes a coil spring.

15. The system of claim 1 wherein the gantry carries a cutting device.

16. The system of claim 1 wherein the gantry carries a liquid jet cutting head.

17. A gantry carriage for use with a material processing machine having a guide shaft, the gantry carriage comprising:
a mounting structure;
a motor operably coupled to the mounting structure;
a drive wheel operably coupled to the motor and configured to movably engage the guide shaft to move the mounting structure relative to the guide shaft in response to operation of the motor; and
one or more guide wheels rotatably coupled to the mounting structure, wherein the guide shaft has an outer surface portion with a convex cross-sectional shape, wherein each of the one or more guide wheels has an annular outer portion with a concave cross-sectional shape, and wherein the concave cross-sectional shape is substantially complementary to the convex cross-sectional shape.

18. The gantry carriage of claim 17 wherein the convex cross-sectional shape has a first radius of curvature, and wherein the concave cross-sectional shape has a second radius of curvature that is the same as the first radius of curvature.

19. The gantry carriage of claim 17 wherein the one or more guide wheels include a first guide wheel and a second guide wheel spaced apart from the first guide wheel, and wherein the first and second guidewheels are configured to contact a same side of the guide shaft.

20. The gantry carriage of claim 17 wherein the one or more guide wheels include a first guide wheel positioned on a first side of the motor and a second guide wheel positioned on a second side of the motor, opposite the first side.

21. The gantry carriage of claim 17 wherein the annular outer portion of each of the one or more guide wheels is configured to conformably contact the outer surface portion of the guide shaft.

22. The gantry carriage of claim 17 wherein the annular outer portion includes at least one of an acetal homopolymer, polyoxymethylene, and/or Delrin.

23. The gantry carriage of claim 17 wherein the annular outer portion has a flexural modulus of between about 400,000 psi and about 500,000 psi.

24. The gantry carriage of claim 17 wherein the annular outer portion has a compressive modulus of between about 400,000 psi and about 500,000 psi.

25. The gantry carriage of claim 17 wherein the material processing machine further includes a cutting head movably mounted to a gantry, and wherein the mounting structure is configured to support the gantry.

26. A material processing machine, comprising:
a cutting head;
a cutting table configured to support a workpiece relative to the cutting head;
a guide shaft adjacent the cutting table; and
a drive system configured to move the cutting head relative to the cutting table, wherein the drive system includes—
a mounting structure;
a motor operably coupled to the mounting structure;
a drive wheel drivably coupled to the motor and configured to contact a first side of the guide shaft, wherein the motor is configured to rotate the drive wheel to cause the mounting structure to move along the guide shaft;
a pinch wheel configured to contact a second side of the guide shaft opposite the first side;
a biasing member configured to bias at least one of the pinch wheel or the guide wheel toward the other of the pinch wheel or the drive wheel to drivably engage the guide shaft therebetween; and
a guide wheel spaced apart from the motor and rotatably coupled to the mounting structure, wherein the guide wheel is configured to contact the second side of the guide shaft.

27. The material processing machine of claim 26 wherein the motor is configured to (i) move the mounting structure along a first axis parallel to the guide shaft, and to (ii) move relative to the mounting structure and along a second axis, different than the first axis.

28. The material processing machine of claim 27 wherein the second axis is perpendicular to the first axis.

29. The material processing machine of claim 27 wherein the first axis is a horizontal axis and wherein the second axis is a vertical axis.

30. The material processing machine of claim 26, further comprising a motor guide shaft configured to movably couple the motor to the mounting structure and allow the motor to move along a length of the motor guide shaft relative to the mounting structure.

31. The material processing machine of claim 26 wherein the drive system enables the motor to resiliently maintain vertical alignment with the guide shaft.

32. The material processing machine of claim 26 wherein the guide shaft has an outer surface portion with a convex curvature, and wherein the guide wheel has an annular outer portion with a concave curvature configured to complementarily engage the convex curvature.

33. The material processing machine of claim 32 wherein the concave curvature of the guide wheel has a same radius of curvature as the convex curvature of the guide shaft.

34. The material processing machine of claim 33 wherein the annular outer portion of the guide wheel is configured to resiliently deform to conform to the outer surface portion of the guide shaft.

35. The material processing machine of claim 34 wherein the annular outer portion of the guide wheel includes at least one of an acetal homopolymer, polyoxymethylene, and/or Delrin.
